(19) United States
(12) Patent Application Publication
(10) Pub. No.: US 2003/0099811 A1
(43) Pub. Date: May 29, 2003

(54) Fastener part

(76) Inventor: Konstantinos Poulakis, Hildrizhausen (DE)

Correspondence Address: Mark S Bicks, Roylance Abrams Berdo & Goodman, Suite 600, 1300 19th Street NW, Washington, DC, 20036, US

(21) Appl. No.: 10/312,781

(22) PCT Filed: Aug. 10, 2001
(86) PCT No.: PCT/EP01/09238

(30) Foreign Application Priority Data
Aug. 16, 2000 (DE) 100-39.940.1

(51) Int. Cl. B32B 3/06

(52) U.S. Cl. 428/126; 428/99; 428/100

(57) ABSTRACT

The invention relates to a fastener part, especially for use in a foaming production method, comprising a support strip (10) on which hook elements (12) are located, and a cover strip (20) which covers said support strip (10) on the side facing away from the hook elements (12) and which is wider than the support strip (10), so that free lateral edge areas (21) of the cover strip (20) extend beyond the associated longitudinal edges (33) of the support strip (10) on both sides. The two free lateral edge areas (21) of the cover strip (20) are folded over on themselves in the direction of the support strip (10), along a folding line (29) extending in the longitudinal direction, so that the end edges (31) of the free lateral edge areas (21) of the cover strip are turned towards the longitudinal edges (33) of the support strip (10). The folding line (29) forms a kind of sealing lip which has at least one sealing surface which functions outwardly in the direction of the respective foam and which is closed in itself. As a result of this configuration, a foam barrier is formed by the lateral edge areas of the cover strip and guarantees an absolute seal. At the same time, production costs and possible damage to the environment are reduced.

The invention relates to a fastener part, especially for use in foaming production processes, with a backing strip having engaging elements mounted on it and with a cover strip covering the backing strip on the side facing away from the engaging elements, the cover strip being wider than the backing strip, so that free lateral edge areas of the cover strip project beyond the associated longitudinal edges of the backing strip.

Fastener parts of this type, in which a plurality of integral engaging elements in the form of stems having thickened areas on the engaging or front side of the backing strip, are commercially available. A production process for manufacture of the backing strip of such fastener parts is described in DE 198 28 856 C1. In this process a thermoplastic, polyolefin or polyamide in particular, in the plastic or liquid state, is introduced into a gap between a pressure-application tool and a shaping tool, a screen having through openings being used and the engaging elements being formed by the thermoplastic solidifying at least in part in the openings in the screen. A so-called microfastener with 200 to 400 engaging elements per square centimeter is formed in this manner. A backing strip in the form of a textile material may also be provided in place of the mushroom-shaped engaging elements thereby formed, a strip on which the engaging elements are formed by a looped material integral with the textile backing strip, for example. However, a pad or a felt structure may also be employed in place of the looped material.

Fasteners made in this way are used for many purposes, as in automotive engineering and carpet installation, for clothing of all kinds, and special applications in mechanical engineering. The fasteners have proved themselves in these areas as detachable and dependable connection and fastening technology.

When such fastener parts are used for aircraft or motor vehicle seats their purpose is to fasten seat covers to foamed parts, some fastener parts also being foamed into the foamed upholstery material during production of each seat and the fastener part being secured, sewed in particular, on the upholstery covering material with the corresponding engaging elements. For production of the foamed element parts the fastener parts are introduced into so-called intake pipes of a foam injection mold, and the fastener parts are secured during the foam injection process on the foamed element parts by introduction of foamed material into the free cross-sections of the foam injection mold, preferably of polyurethane foam. The pipes used generally project beyond the remainder of the walls of the foam injection mold and so later form groove-like recesses in the foamed element part, into which recesses the upholstery cover material then enter with the other corresponding fastener part. Seam and mold geometries on a particular seat can be reproduced in this way.

In order to prevent foamed material from penetrating the area of the engaging elements during removal of foam from a foam injection mold, with the result that the engagement action of these elements would be destroyed, the commercially available fastener parts for such applications are provided on the rear side of the backing strip facing away from the engaging elements with a cover strip which is wider than the backing strip, so that free lateral edge areas of the cover strip extend beyond the backing strip on both sides (for example, in accordance with subsequently published German patent application 199 56 011.0). The projecting lateral edge areas serve the purpose of forming a foam barrier, these lateral edge areas resting against the mold wall of the foam injection mold, which enclose a mold trough which receives the backing strip with the engaging elements. As a result of securing of the fastener part on the wall of the foam injection mold, something which may be accomplished by use of magnetic fixing means, for example, application of the lateral side areas of the projecting cover strip prevents entry of foam into the mold trough receiving the engaging elements.

U.S. Pat. No. 4,784,890 discloses a generic fastener part, the free lateral edge areas of the cover strip each having an adhesive sealing strip fastened on it in accordance with the solution disclosed. On the front ends of the disclosed fastener part a clamp-like sealing arch as auxiliary sealing means is adhesively connected at least to the bottom of the backing strip, this auxiliary sealing means extending over the side facing away from the fastener element with its engaging elements. Production of this fastener part is time-consuming and cost-intensive, since sealing strips which are only prepared and manufactured separately remain to be joined by adhesion to the backing strip as base material. Depending on the production process, it cannot always be made certain that the adhesive connection is strong and ensures dependable sealing so that the foam material will if necessary have an adequate application area available to it for breaking the seal, something which may result in rendering the engaging elements useless.

DE-U-90 13 133 further discloses design of fastener parts for injection into a foam briquet, the fastener part being a section of an adhesive strip which is occupied only by a center strip extending over the entire length of the adhesive strip for formation of a fastener strip with engaging elements bordered by longitudinal edges. In the disclosed solution the entire front side of the fastener part is covered by cover foil the edges of which at least are joined to the edges of the fastener part, strips of magnetic plastic being secured over the longitudinal edges of the adhesive strip. The cover foil, whose preparation and application entails corresponding production costs, is used as protection for the engaging elements from the foam material, because of the deficient sealing effect of the magnetic plastic strips in question. In addition, the cover foil must be removed from the fastener part and disposed of in another operating cycle before the engaging elements become active.

On the basis of this state of the art the invention pursues the object of optimizing the disclosed fastener parts of the type referred to in the foregoing, to the end that an absolutely reliable sealing effect is ensured by a foam barrier formed by the lateral edges of the cover strip, along with reduction of the production cost and possible harm to the environment. This object is attained by a fastener part having the characteristics specified in patent claim 1 in its entirety.

In that, as claimed for the invention, both lateral edge areas of the cover strip are folded over themselves along a fold line extending longitudinally toward the backing strip, so that the end edges of the free lateral edge areas of the cover strip face the longitudinal edges of the backing strip, and in that the fold line forms a sort of sealing lip having at least one self-contained sealing surface which acts outward in the direction of the respective foam, the sealing lip always extends along the area having the engaging elements, the respective sealing lip resting against the wall parts of the foam injection mold which enclose the mold trough into which the engaging elements are received during the foaming process. This sealing lip is forced against the facing wall parts of the mold by the foam material introduced into the foam injection mold, such sealing lip fitting snugly against the wall areas forming the sealing surface because of a certain degree of elasticity in the area of the fold line, so that the sealing effect of the foam barrier is distinctly improved over that of the disclosed solutions. Since, in addition, the sealing lip forms a closed sealing surface extending outward, it is impossible for the foam to enter any cavities in the area of the fold line between the superposed wall areas of the cover strip, so that the solution claimed for the invention virtually precludes failure.

Since production of the sealing lip function in question requires no added or original materials, production is also simplified; this in turn has a favorable effect on production costs. Since additional materials are dispensed with, especially materials for covering the fastener material itself, there is no problem of disposal of a cover foil and the fastener solution claimed for the invention is to be classified as environmentally friendly.

A preferable embodiment of the fastener part is characterized in that the fold lines subdivide the free lateral edge areas of the cover strip into partial areas and in that the superposed partial areas may be brought into contact with each other free of adhesive by their sides facing each other. The fastener part claimed for the invention thus dispenses with application of adhesive for production of the respective sealing lip areas; this promotes lowering of production costs and also favors the environment, since addition of adhesive containing a solvent may be eliminated.

In another preferred embodiment of the fastener part claimed for the invention which is characterized in that the partial areas of each lateral edge are each of equal width, and in particular are in the form of halves, and in that the end edges of the respective lateral edge area are more or less flush with the longitudinal edges of the backing strip, it is possible for the end edges of the cover strip to rest on the longitudinal edges of the backing strip, so that the sealing lip may not be unintentionally displaced back inward in the direction of the backing strip by the impending penetrating action of the foam.

In one preferred embodiment the cover strip possesses magnetic properties at least in its free lateral edge areas, so that the fastener part may be kept in place by means of a magnetic retaining device on the injection mold, such as one in the form of strips of permanent magnets embedded in the injection mold or the intake pipes of the foam injection mold oriented toward the lateral edge areas of the cover strip.

The cover strip preferably has a mat with embedded ferromagnetic particles which is joined by way of connecting means to the side of the backing strip which faces away from the side having the engaging elements.

The connecting means may be in the form of a layer of adhesive material.

In order to impart a certain bending resistance to the fastener part, something which facilitates handling of the backing strip during introduction into the foam injection mold, and especially if predetermined lengths of the fastener part in the form of complex three-dimensional structures are to be introduced into the foam injection mold involved, a stiffening section may be embedded in the adhesive layer present between cover strip and backing strip. Such section may be represented by iron wire which is provided with a coating to resist corrosion, and especially is zinc-plated. When a ferromagnetic stiffening wire is used, such wire may also contribute to magnetic securing of the position of the fastener part on the foam injection mold.

The engaging elements of the fastener part claimed for the invention may be made of a plastic material, preferably polyester.

The engaging elements may be in the form of hook-shaped and/or mushroom-shaped fastening elements and/or of loop-like or pad-like engaging material.

One embodiment of the fastener part claimed for the invention is discussed in detail in what follows with reference to the drawings, in which, as a basic diagram not drawn to scale,

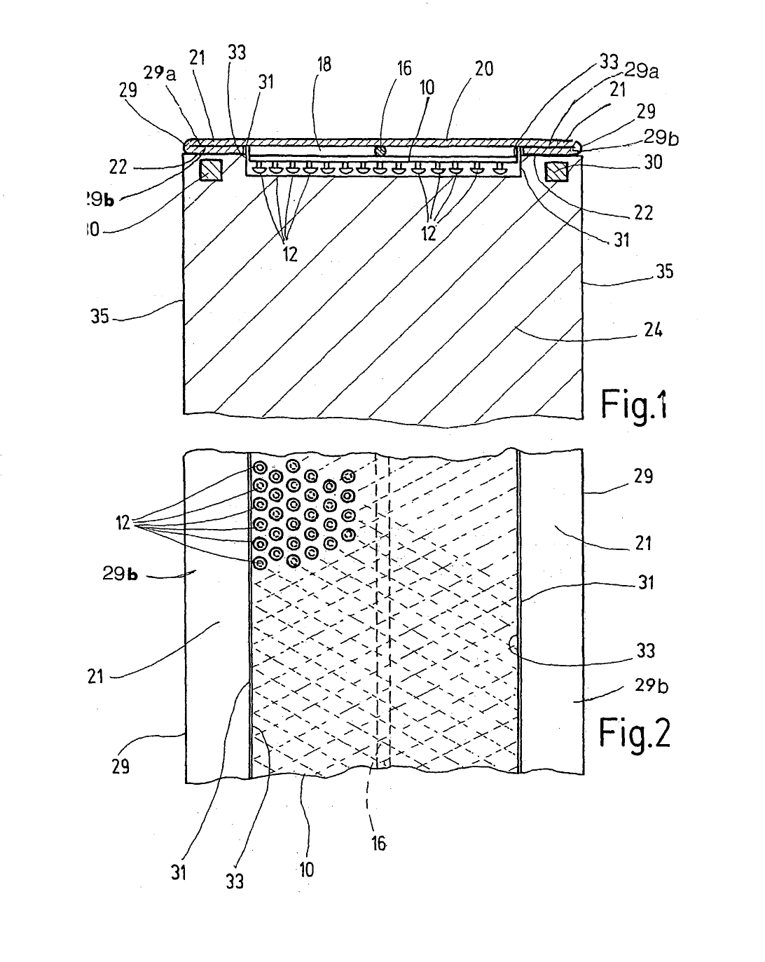

FIG. 1 shows a section of an intake pipe of a foam injection mold, a fastener part having been introduced into the mold trough (partly in section, partly as direct view),

FIG. 2 a top view of the fastener part, as seen in the line of sight toward its front side having engaging elements.

The fastener part claimed for the invention has a backing strip 10. Engaging elements 12 arranged in rows side by side and in succession are present on one side of the backing strip 10. The fastener part in question may, for example, be a so-called microfastener, in which 200 to 400 engaging elements per square centimeter are provided on a backing strip 10 0.1 to 0.3 millimeter thick. A process for production of the backing strip of such a microfastener is disclosed in DE 198 28 856 C1. In this disclosed process a thermoplastic is introduced into the gap between a pressure tool and a shaping tool, a sieve having through openings being used as shaping element and in which the engaging elements are formed by the plastic solidifying at least to some extent in the openings in the sieve.

The backing strip 10 has a bending resistant rigidification section which extends over the entire length of the backing strip 10. This rigidification section consists, in the case of the embodiment illustrated, of a wire 16, especially in the form of a metal wire. This wire 16 is connected by way of connecting means designated as a whole as 18 to the backing strip 10 on the rear side of such means facing away from the engaging elements 12.

In particular a layer of adhesive in which the wire 16 is embedded serves as the connecting means 18. This adhesive layer may consist of a moisture-interlacing polyurethane. The connecting means 18 covers one side of the backing strip 10 in its entirety and is rigidly connected to this strip. The diameter relationships selected are such that the thickness of the connecting means 18 in the form of the adhesive layer corresponds to the thickness of the wire 16. However, it is would also be conceivable for the wire 16 with its assigned diameter to be received only in part by the thickness of the connecting means 18.

The connecting means 18 has on its side facing away from the backing strip 10 a cover strip 20 in the form of a textile or plastic mat. The cover strip 20 projects laterally a predetermined distance along the longitudinal edges 33 of the backing strip 10, that is, a free lateral edge area 21 of the cover strip 20 is formed on both sides of the backing strip 10, this free lateral edge area 21 being provided for the purpose of resting against the wall parts 22 on the upper side of an intake pipe 24 which is the component of a foam injection mold which is not shown in FIG. 1. The intake pipe 24 has a mold trough in the form of a recess 28 whose free cross-section is adapted to the backing strip 10 of the fastener part with its engaging elements 12 to be received into this mold trough. The engaging elements 12 generally come into contact on the front side with the bottom of the recess 28.

The free lateral edge areas 21 of the cover strip 20 are, as is to be seen from FIG. 1, folded over themselves in the direction of the front side having the engaging elements 12, that is, toward the side facing the intake pipe 24, the fold lines 29 always extending in the longitudinal direction of the cover strip 10 and in the case of the embodiment illustrated are aligned with the side walls 35 of the intake pipe 24. Consequently, when a fastener part rests against the intake pipe 24 as shown in FIG. 1, the cover strip 20 rests on the wall parts 22 which delimit the mold trough or recess 28 laterally with a double layer of material. This double layer of the folded over cover strip 20 is made up of two partial areas 29a,b, which, superposed one on the other by their sides facing each other may be positioned one against the other preferably free of adhesive. The layout in question is favored by the effect of the foam, which effect promotes sealing. The double layer in question of the folded cover strip 20 exerts its effect especially in the foaming process as a lip seal which prevents entry of the foam material into the recess 28 so that the engaging elements 12 of the backing strip 10 which are received into the recess 28 are protected from the danger of being glued together by penetrating foam material.

There are mounted along the wall parts 22 of the intake pipe 24 strips of permanent magnets 30 or a row of individual permanent magnets which, together with the ferromagnetic property of the cover strip 20, form a magnetic retaining device by which the folded lateral edge areas 21 of the cover strip 20 and accordingly the fastener part are secured on the intake pipe 24. The cover strip 20, which preferably is in the form of a mat, especially one of plastic, preferably polyester, acquires its ferromagnetic property by embedding of ferromagnetic particles in the material of the cover strip. The use of a mat as cover strip makes possible good crosslinking with the polyurethane mold foam introduced into the foam injection mold for the production of upholstered parts for passenger seats, so that reliable anchoring of the fastener parts on the upholstered part is ensured by the foam injection.

1. A fastener part, especially for use in foam production processes, with a backing strip (10) with engaging elements (12) mounted on it and with a cover strip (20) overlapping the backing strip (10) on the side facing away from the engaging elements (12), which cover strip (20) is wider than the backing strip (10), so that the free lateral edge areas (21) of the cover strip (20) extend beyond the associated longitudinal edges (33) of the cover strip (10) on both sides, characterized in that both free lateral edge areas (21) of the cover strip (20) are folded over each other in the direction of the backing strip (10) along a fold line (29) extending longitudinally, so that the end edges (31) of the free lateral edges (21) of the cover strip (20) face the longitudinal edges (33) of the backing strip (10), and in that the fold line (29) forms a sort of sealing lip which has at least one self-contained sealing surface acting outward in the direction of the respective foam.

2. The fastener part as claimed in claim 1, wherein the fold lines (29) subdivide the free lateral edge areas (21) of the cover strip (20) into partial areas (29a,b) and wherein the superposed partial areas (29a,b) may be brought into contact with each other free of adhesive by their sides facing each other.

3. The fastener part as claimed in claim 2, wherein the partial areas (29a,b) of each lateral edge area (21) are of equal width and in particular are in the form of equal halves and wherein the end edges (31) of the respective lateral edge area (21) are more or less flush with the longitudinal edges (33) of the backing strip (10).

4. The fastener part as claimed in claim 1 or 2, wherein the cover strip (20) possesses ferromagnetic properties at least in its free lateral edge areas (21).

5. The fastener part as claimed in claim 4, wherein the cover strip (20) contains embedded ferromagnetic particles.

6. The fastener part as claimed in claim 4 or 5, wherein the cover strip (20) has a mat with embedded ferromagnetic particles.

7. The fastener part as claimed in claim 6, wherein the mat is joined by connecting means (18) on one side of the backing strip (10) to such backing strip (10), which side of the backing strip (10) faces away from the other side having the engaging elements (12).

8. The fastener part as claimed in claim 6, wherein the connecting means (18) is in the form of a layer of an adhesive (18).

9. The fastener part as claimed in claim 8, wherein a stiffening section, especially an iron wire (16), is embedded in the layer of adhesive (18).

10. The fastener part as claimed in claims 6 to 8, wherein the mat of the cover strip (20) is made of plastic material, preferably of polyester.

11. The fastener part as claimed in claims 1 to 9, wherein the engaging elements (12) are made in the form of hook-shaped and/or mushroom-shaped fastening elements and/or of loop-like or pad-like engaging material.
